(19) United States
(12) Patent Application Publication
(10) Pub. No.: US 2005/0184826 A1
(43) Pub. Date: Aug. 25, 2005

(54) Filter

(75) Inventors: Kei Satoh, Yokosuka-shi (JP); Shoichi Narahashi, Yokohama-shi (JP); Tetsuo Hirota, Kanazawa-shi (JP); Yasushi Yamao, Yokosuka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 11/046,885

(22) Filed: Feb. 1, 2005

(30) Foreign Application Priority Data
Feb. 3, 2004 (JP) 2004-027188

(51) Int. Cl. H01P 1/203; H01B 12/02

(52) U.S. Cl. 333/99 S; 333/204; 505/210

(57) ABSTRACT

A filter is provided which maintains a low insertion loss characteristic of a filter contained in a casing with a very simple construction that the internal wall of the casing is formed by a superconductor. A coplanar waveguide filter 22 comprises a dielectric substrate 1, a plurality of resonators 5a, 5b, 5c and 5d and input/output terminal sections 4a and 4b, each of which is formed by a center conductor 2 and ground conductors 3a and 3b, both formed on the same surface of the dielectric substrate 1, with the ground conductors 3a to 3d being formed on the opposite sides of and in parallel relationship with the center conductor 2. The filter 22 is contained within a casing 21 having an internal wall, the surface of which is formed with a layer of superconductor 23. By way of example, a high temperature superconductor such as lanthanum-, yttrium-, bismuth- or thallium-superconductor is deposited as a film on a substrate of a metal oxide material such as MgO, SrTiO₃, LaGaO₃, LaAlO₃ to provide a superconductor filmed substrate 25, which is applied to the internal surface of the casing 21. Electromagnetic power which is irradiated from the filter 22 does not produce a power loss when it impinges on the layer of superconductor 23 in its superconducting state, but is reflected therefrom to be absorbed by the filter 22, thus reducing the filter insertion loss.

### BACKGROUND OF THE INVENTION

The present invention relates to a filter which is used in a selective separation of signals in a particular frequency band in the field of a mobile communication, a satellite communication, a fixed microwave communication and other communication technologies, for example, and in particular, to such a filter which is contained in a metal casing.

Recently, a filter which uses a superconductor is proposed as a filter which is used in the separation of signals in the transmission and reception of a microwave communication, and a variety of constructions are used to construct such a filter including a cavity resonator construction, a microstrip line construction, a coplanar line construction in a flat sheet circuit configuration or the like.

The concept of a coplanar line will be described with reference to FIG. 1. In FIG. 1, formed on a dielectric substrate 1 are a ribbon-like center conductor 2, and a first and a second ground conductor 3a and 3b which are equally spaced from the center conductor 2 on the opposite sides thereof. The three members including the center conductor 2, the first and the second conductor 3a and 3b are formed parallel to and coplanar with each other on the common surface of the dielectric substrate 1. The coplanar line has features that no via-holes are required in forming a one-quarter wavelength resonator, a miniaturization is possible without changing a characteristic impedance and that a greater freedom of design is available. Denoting the width of the center conductor 2 by w and the spacing between the center conductor 2 and each of the first and the second ground conductors 3a and 3b by s, the coplanar line has a characteristic impedance which is determined by the line width w of the center conductor and the spacing d(w+2s) between the first and the second ground conductor 3a and 3b.

Referring to FIGS. 2A to 2C, a conventional example of the coplanar waveguide filter will be described. This example is what is disclosed in a literature: H. Suzuki, Z. Ma, Y. Kobayashi, K. Satoh, S. Narahashi and T. Nojima, “A low-loss 5 GHz bandpass filter using HTS quarter-wavelength coplanar waveguide resonators”, IEICE Trans. Electron., vol. E-85-C, No. 3, pp714-719, March 2002. In this example, a first to a fourth resonator 5a to 5d are disposed on a line. Each resonator comprises a center conductor 2 having an electrical length equivalent to one-quarter wavelength and a first and a second ground conductor 3a and 3b disposed on the opposite sides of and parallel to the center conductor 2 and spaced therefrom by a spacing s, which are formed on the common surface of a dielectric substrate 1.

A first input/output terminal section 4a of a coplanar line type to which a signal is input is capacitively coupled to the first resonator 5a. In the example shown, one end of a center conductor 2₄ₐ of the first input/output terminal section 4a and one end of a center conductor 2_{R1} of the first resonator 5a are disposed in mating relationship with each other in the manner of comb teeth and spaced by a gap g1 in order to strengthen the capacitive coupling, thus forming a first capacitive coupler 6a. The other end of the center conductor 2_{R1} and one end of a center conductor 2_{R2} of a second resonator 5b are connected together by shorting line conductors 7a1 and 7a2, which are in turn connected to the first and the second ground conductor 3a and 3b, respectively, thus forming a first inductive coupler 8a between the first and the second resonator 5a and 5b.

Cuts 20 are formed into the first and the second ground conductor 3a and 3b on each side of the shorting line conductors 7a1 and 7a2, whereby the shorting line conductors 7a are apparently extended, increasing the degree of coupling of the first inductive coupler 8a. A gap g2 is provided between the other end of the center conductor 2_{R2} of the second resonator 5b and one end of a center conductor 2_{R3} of a third resonator 5c, whereby the second and the third resonator 5b and 5c are coupled together by a second capacitive coupler 6b.

The other end of the center conductor 2_{R3} and one end of a center conductor 2_{R4} of a fourth resonator 5d are connected together by shorting line conductors 7b1 and 7b2 and connected to the ground connectors 3a and 3b through these shorting line conductors 7b1 and 7b2, whereby the third and the fourth resonator 5c and 5d are coupled together by a second inductive coupler 8b. In the second inductive coupler 8b, also cuts 21 are formed into the ground conductors 3a and 3b

The fourth resonator 5d and a second input/output terminal section 4b are capacitively coupled. Specifically, the other end of the center conductor 2_{R4} and a center conductor 2₄ₐ of the second input/output terminal section 4b are formed in the configuration of meshing comb teeth and disposed in opposing relationship and spaced apart by a gap g3, thus forming a third capacitive coupler 6c which provides a strong coupling therebetween.

In order to reduce a loss caused by an irradiation of electromagnetic power from the filter which defines a coplanar waveguide filter, it is contained in a square tubular metal casing 10 as shown in FIG. 3, for example, allowing the electromagnetic power which is irradiated from the coplanar waveguide filter to be recovered by the filter again. The coplanar waveguide filter 11 is disposed in opposing relationship and parallel to one side plate of the metal casing 10, and the internal space of the metal casing is substantially halved by the coplanar waveguide filter 11. The electromagnetic power which is irradiated from the coplanar waveguide filter 11 is reflected by the internal surface of the metal casing 10 substantially in its entirety and a majority of the irradiated electromagnetic power is recovered by the filter 11, thus alleviating a radiation loss.

In a conventional filter which is confined within a metal casing, the electromagnetic power which is irradiated from the filter contained in the metal casing is reflected by the internal surface of the metal casing, and the majority of the electromagnetic power is recovered by the filter. However, a potion of electromagnetic power which is irradiated from the filter becomes an induced current which follows through the metal on the internal surface of the metal casing 10, presenting a problem of radiation loss. This problem is not limited to a coplanar waveguide filter, but also occurs in a microstrip line filter which is contained within a metal casing.

### SUMMARY OF THE INVENTION

It is an object of the present invention to provide a filter which reduces a radiation loss occurring in a filter contained within a casing.

In a filter contained within a casing and comprising at least one resonator formed by a signal conductor formed on at least one surface of a dielectric substrate and an input/output terminal section formed on the dielectric substrate and coupled with the resonator, in accordance with the present invention, the casing has an internal wall surface which is formed by a superconductor layer.

The signal conductor mentioned above refers to a center conductor of a coplanar line or a signal line of a microstrip line resonator.

With the arrangement according to the present invention, a very simple structure that the internal wall surface of the casing is formed by a superconductor layer can be used and the superconductor layer may be maintained in its superconducting state to prevent a loss from occurring if part of the electromagnetic power which is irradiated from the filter causes an induced current to flow through the internal wall surface of the casing inasmuch as the superconductor layer presents a resistance of zero to the flow of the induced current. Accordingly, the filter contained in the casing has a reduced loss in comparision to the prior art.

### BRIEF DESCRIPTIONS OF THE DRAWINGS

FIG. 1 is a perspective view illustrating the concept of a coplanar line;

FIG. 2A is a plan view of a conventional coplanar waveguide filter;

FIG. 2B is a right-hand side elevation of FIG. 2A;

FIG. 2C is a front view of FIG. 2A;

FIG. 3 is a perspective view of a conventional coplanar waveguide filter contained within a casing;

FIG. 4 is a perspective view of an embodiment of the present invention in which a superconductor layer is formed on the internal surface of the casing;

FIG. 5 graphically shows an exemplary characteristic impedance plotted against the ratio k of the center conductor line width with respect to the ground conductor spacing in a filter according to the first mode of carrying out the invention;

FIG. 6A is a plan view of one-quarter wavelength four stage coplanar waveguide filter according to the first mode of carrying out the invention;

FIG. 6B is a right-hand side elevation of FIG. 6A;

FIG. 6C is a front view of FIG. 6A;

FIG. 7 graphically shows a current density distribution of the one-quarter wavelength four stage coplanar waveguide filter shown in FIG. 6;

FIG. 8 graphically shows a current density distribution of an inductive coupler in the one-quarter wavelength four stage coplanar waveguide filter shown in FIG. 6;

FIG. 9 graphically shows a current density distribution of the one-quarter wavelength four stage coplanar waveguide filter shown in FIG. 2;

FIG. 10 graphically shows a current density distribution of an inductive coupler in the one-quarter wavelength four stage coplanar waveguide filter shown in FIG. 2;

FIG. 11 graphically shows a result of simulations for the transmission frequency response of the filter of the prior art and the filter according to the first embodiment;

FIG. 12 is a plan view of an embodiment in which the first embodiment is applied to a single stage resonator filter;

FIG. 13 is a perspective view illustrating the application of the present invention to a microstrip line resonator filter;

FIG. 14A is a plan view of the filter contained in the embodiment shown in FIG. 13;

FIG. 14B is a right-hand side elevation of FIG. 14A and;

FIG. 14C is a front view of FIG. 14A.

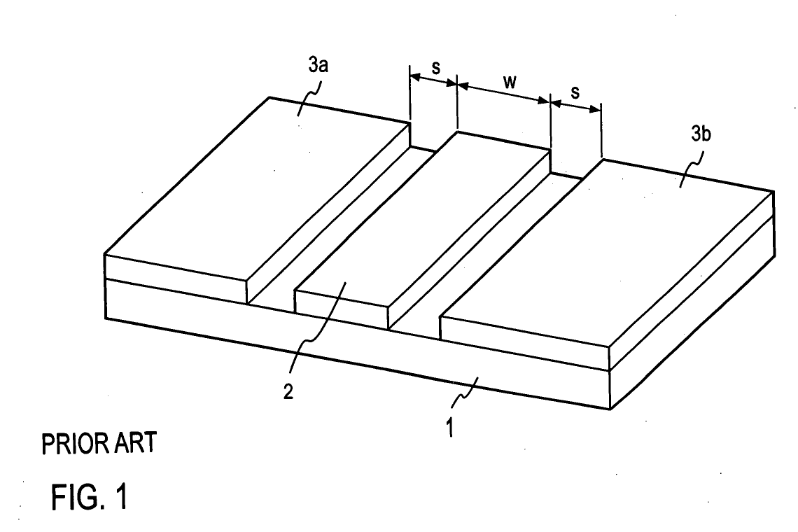

### BEST MODES FOR CARRYING OUT THE INVENTION

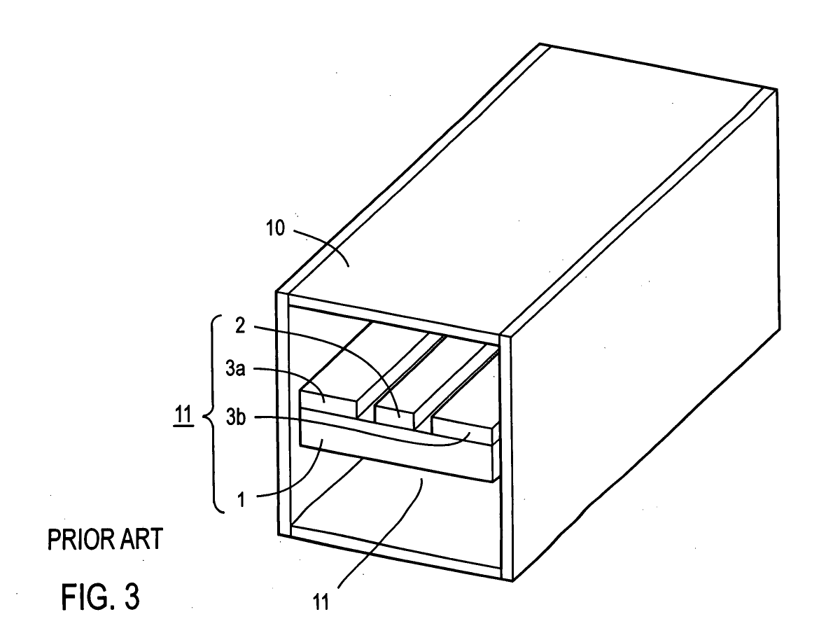

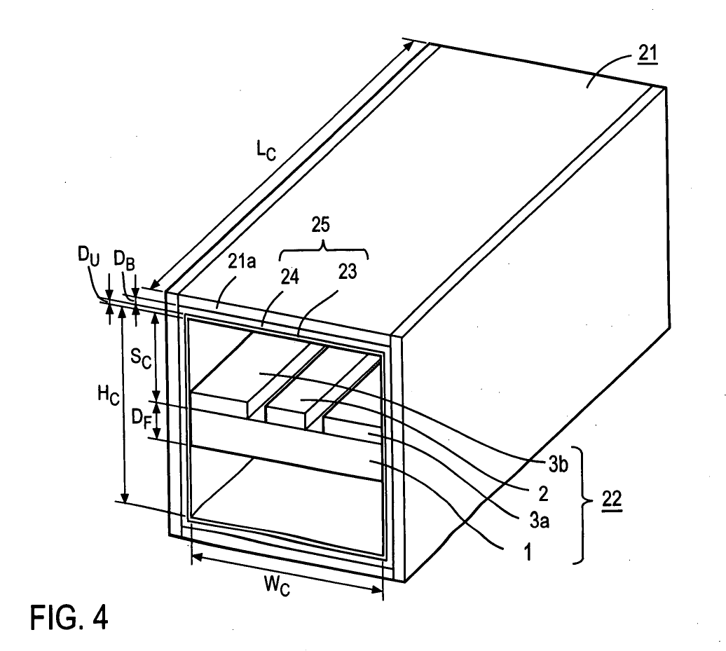

One embodiment of the present embodiment is shown in FIG. 4. Contained within a square tubular casing 21 is a coplanar waveguide filter 22, which comprises a center conductor 2 and ground conductors 3a and 3b disposed on the opposite sides of the center conductor, both formed on a dielectric substrate 1. The coplanar waveguide filter 22 has a length which is equal to the length L_{c} of the casing 21 so that the filter 22 is a just fit therein. While not shown, the filter includes a resonator and a first and a second input/output terminal section. In the similar manner as one shown in FIG. 3, the filter 22 is disposed so as to oppose one sidewall of the casing 21, which is halved by the filter 22. To give an example, the casing 21 has a width W_{c} of 5.4 mm, a height H_{c} of 8 mm and a length L_{c} of 30 mm and there is a spacing S_{c} of 4.5 mm between the dielectric substrate 1 and the casing 21. In this embodiment, the internal wall surface of the casing 21 is formed by a superconductor layer 23. By way of example, a square tubular outer wall body 21a is formed of a metal material, for example, in order to maintain the configurational integrity of the casing 21, and the entire internal surface of the outer wall body 21a is formed by the superconductor layer 23. The superconductor layer 23 can be formed by depositing lanthanum-, yttrium-, bismuth-, thallium- or other high temperature superconductor on a substrate 24 of metal oxide material such as MgO, SrTiO₃, LaGaO₃ or LaAlO₃ by a film forming method such as sputtering, vacuum evaporation, CVD process or silk screening thick film formation or the like to define the superconducting layer 23, and a resulting substrate 25 with a film of superconductor is applied, as with an adhesive, to the internal surface of the outer wall body 21a. In the example shown, the substrate 25 with a film of superconductor is applied to plate materials which define the outer wall body 21a for the four side walls of the square tubular casing 21 to be assembled into the square tubular casing 21.

The superconductor layer 23 has a thickness which is chosen so that in the event the electromagnetic power which is irradiated from the filter 22 impinges on the internal surface of the casing 21 to produce a current flow, a sufficiently low resistance, which is substantially equal to zero resistance, is presented to the current flow. By way of example, the superconductor layer 23 has a thickness Dᵤ of 5000Å, and the substrate 24 has a thickness D_{B} equal to 0.5 mm. To maintain the layer 23 of high temperature superconductor in its superconducting state, a material having a high thermal conductivity is preferred to construct the outer wall body 21a, and it is contemplated that a copper plate plated with gold be used at this end in consideration of the erosion resistance.

The electromagnetic power which is irradiated form the coplanar waveguide filter 22 to impinge on the internal wall surface of the casing produces an induced current in the inner wall, producing a power loss of RI² where I represents the current and R the surface resistance of the internal wall of the casing. However, in the example shown in FIG. 4, R is nearly equal to 0, and thus the power dissipation is greatly reduced by the casing 21.

The present invention is particularly effective when an increased amount of electromagnetic power is irradiated from the filter as when there is a mismatch between the characteristic impedance of the input/output terminal section and the characteristic impedance of the resonator, for example. Accordingly, the characteristic impedance of the coplanar waveguide filter will now be considered. A relationship between a current and a voltage on a distributed constant line is generally given by following equations:

$$\dot{I} = \frac{{\dot{V}}_{i}}{Z} {ⅇ}^{- γ z} - \frac{{\dot{V}}_{r}}{Z} {ⅇ}^{γ z} = {\dot{I}}_{i} {ⅇ}^{- γ z} + {\dot{I}}_{r} {ⅇ}^{γ z} \\ Z = \sqrt{\frac{R + jω L}{G + jω C}} , γ = α + β , α = \frac{R}{2} \sqrt{\frac{C}{L}} + \frac{G}{2} \sqrt{\frac{L}{C}} , β = ω \sqrt{LC}$$

where

Iᵢ, Vᵢ: a current value and a voltage value of a traveling wave

Iᵣ, Vᵣ: a current value and a voltage value of a reflected wave

γ: propagation constant

α: attenuation constant

β: phase constant

Z: characteristic impedance

R: series resistance

L: series inductance

G: parallel conductance

C: capacitance.

A current value on a distributed constant line is inversely proportional to the characteristic impedance.

A characteristic impedance of a coplanar waveguide filter is given as follows:

$${Z}_{0} = \frac{{η}_{0}}{4 \sqrt{{ɛ}_{eff}}} \times \frac{{K}^{′} ( k )}{K ( k )}$$

where ε_{eff} represents an effective dielectric constant of a coplanar waveguide filter, η₀ a wave impedance in the free space, K(k) a perfect elliptic integral of first type, and' a derivative.

ε_{eff},η₀ and K(k) are represented as follows:

$${ɛ}_{eff} = 1 + \frac{{ɛ}_{r} - 1}{2} \times \frac{{K}^{′} ( k )}{K ( k )} \times \frac{K ( {k}_{1} )}{{K}^{′} ( {k}_{1} )}$$

$${η}_{0} = \sqrt{\frac{{μ}_{0}}{{ɛ}_{0}}} = 120 π$$

$$K ( k ) = {\int }_{0}^{1} \frac{ⅆ x}{\sqrt{( 1 - {x}^{2} ) \times ( 1 - {k}^{2} {x}^{2} )}}$$

$$k = \frac{w}{d}$$

$${k}_{1} = \frac{sin h ( π w / 4 h )}{sin h ( π d / 4 h )}$$

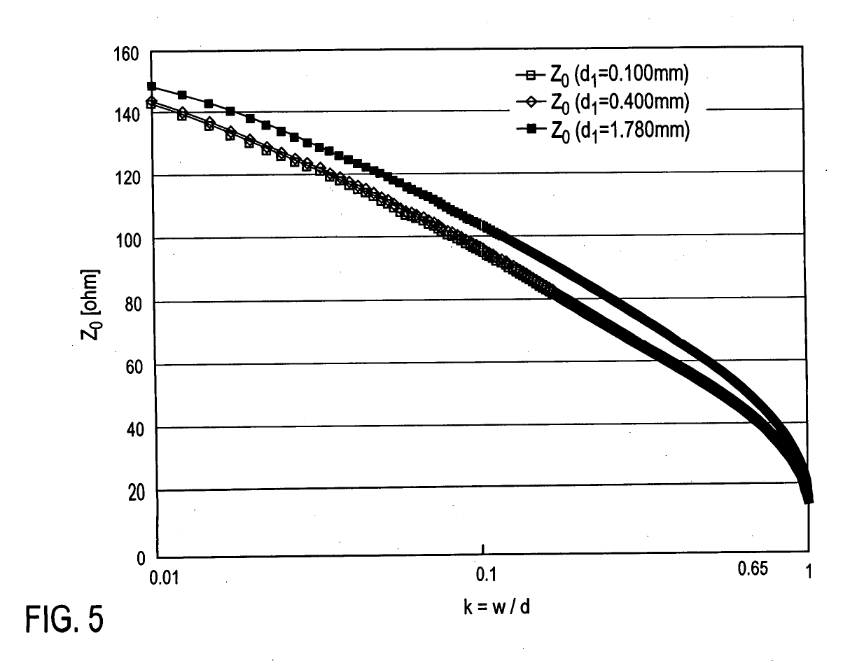

A characteristic impedance Z₀ is determined by the ratio k of the center conductor width w with respect to the ground conductor spacing d, the dielectric constant εᵣ of the dielectric substrate and the thickness h of the dielectric substrate. Thus, as shown in FIG. 5, the characteristic impedance Z₀ can be increased by using the ratio k of the center conductor line width w with respect to the ground conductor spacing d as a parameter. In FIG. 5, the abscissa represents k=w/d and the ordinate represents the characteristic impedance Zₒ with the ground conductor spacing d representing a parameter.

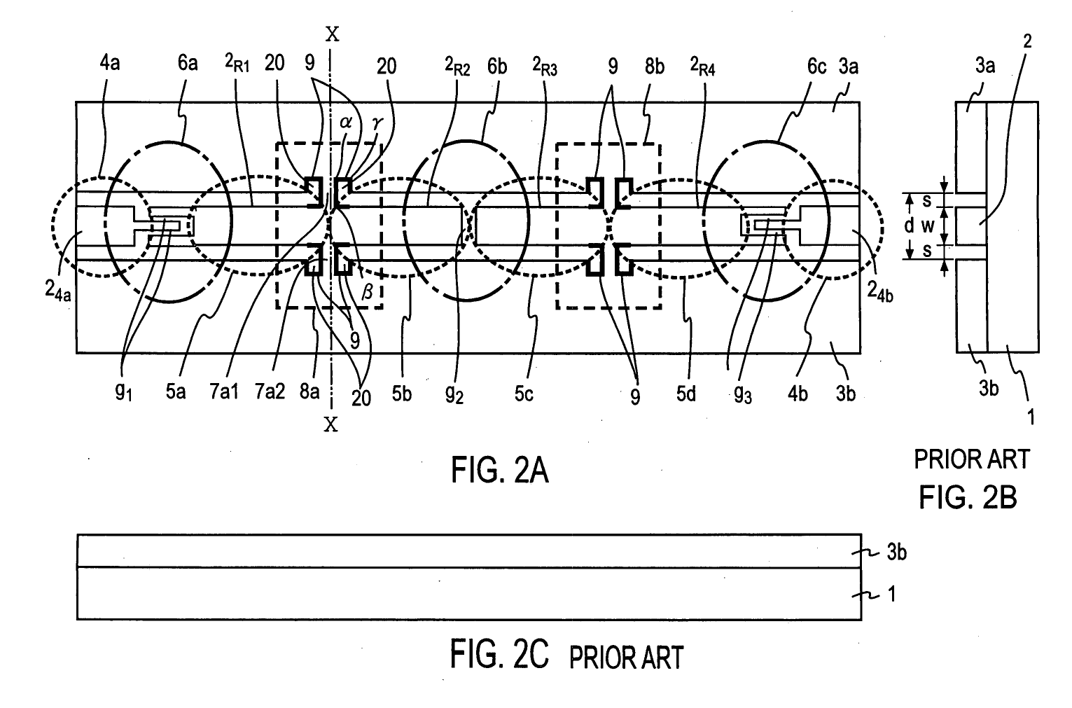

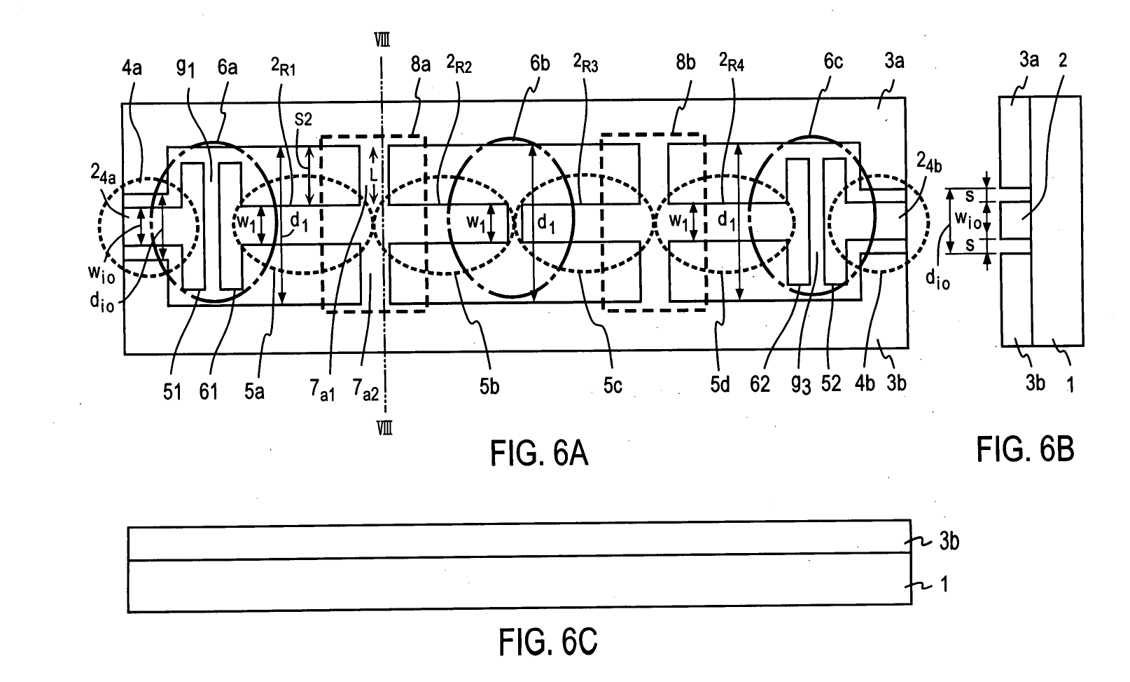

A specific example in which the resonator has a greater characteristic impedance than the input/output terminal section of the coplanar waveguide filter will be described. An example of such coplanar waveguide filter will be described with reference to FIG. 6A to 6C. It is to be noted that parts corresponding to those shown in FIGS. 2A to 2C are designated by like reference numerals as used before without duplicate description. In this example, the first and the second input/output terminal section 4a and 4b have a characteristic impedance of 50Ω while the first to the fourth resonator 5a to 5b have a characteristic impedance of 100Ω. Specifically, MgO substrate having a dielectric constant of 9.68 is used as the dielectric substrate 1, and the first and the second input/output terminal section 4a and 4b have a center conductor width wᵢₒ of 218 μm and a ground conductor spacing dᵢₒ of 400 μm. The first to the fourth resonator 5a to 5b have a center conductor width w₁, of 218 μm and a ground conductor spacing d₁, of 1,780μm.

Capacitive coupling ends 51 and 61 which define a first capacitve coupler 6a between the first input/output terminal section 4a and the first resonator 5a are extended toward the ground conductors 3a and 3b in a manner conforming to the increased ground conductor spacing d₁, and the capacitive coupling ends 51 and 61 oppose each other with a gap g₁ therebetween. The length over which the ends oppose to each other is chosen to be equal to the length over which the coupling ends of the first capacitive coupler 6a shown in FIG. 2 oppose to each other. Thus, the first capacitive coupler 6a is formed as a simple construction that the opposing edges of the coupling ends are formed to be linear without using a complicated construction of mating comb teeth.

Shorting line conductors 7a1 and 7a2 which couple between the first resonator 5a and second resonator 5b has a sufficient length to provide a satisfactory degree of coupling for an inductive coupler 8a due to an increased ground conductor spacing d₁ as compared with the prior art, without forming cuts 20 shown in FIG. 2A into the first and the second ground conductor 3a and 3b in regions of junctions between the shorting line conductors 7a1 and 7a2 and the first and the second ground conductor 3a and 3b. As a conseqence, the first inductive coupler 8a is also simpler in construction than that shown in FIG. 2.

A second inductive coupler 8b is constructed in the same manner as the first inductive coupler 8a. In this arrangement, a spacing S2 between each of the center conductors 2_{R1} to 2_{R4} and the ground conductors 3a and 3b is chosen to be equal to the length L of each of the shorting line conductors 7a1, 7a2 and 7b1, 7b2 which define the inductive couplers 8a and 8b, and no rectangular cuts 20 are formed into the ground conductors 3a and 3b.

In other words, the shorting line conductors 7a1 and 7b1 are connected at right angles to the ground conductor 3a and the edge of the junction located toward the ground conductor extends parallel to the center conductor 2_{R1} and 2_{R4} to the positions of the first capacitive coupler 6a and 6b.

As a consequence, a junction between the shorting line conductors 7a and 7b and the ground conductors assumes a simple configuration which facilitates the manufacture while reducing corners on the current carrying line where a current density is likely to be concentrated. An arrangement which follows the first resonator 5a is identical with the arrangement of the one-quarter wavelength four stage coplanar filter described above with reference to FIG. 2, except for the configuration of the coupling ends for the capacitive couplers and that no cuts are formed in the region of junction between the ground conductors and the shorting line conductors which define the inductive coupler. Accordingly, only a connection will be described.

Since the shorting conductors 7a and 7b are constructed in this manner, a spacing between each of the center conductors 2_{R2}, 2_{R3}, 2_{R4} of the resonators 5b, 5c, 5d and each of the ground conductors 3a and 3b is equal to S2. A second capacitive coupler 6a disposed between the second resonator 5b and the third resonator 5c is constructed in the similar manner as the second capacitive coupler 6a shown in FIG. 2. A third capacitive coupler 6c disposed between the fourth resonator 5d and the second input/output terminal section 4b is constructed in the similar manner as the first capacitive coupler 6a shown in FIG. 6. Specifically, a capacitive coupling end 6b at one end of the center conductor 2_{R4} and a capacitive coupling end 52 located at one end of the center conductor 2_{4b} are both wider linear members which are extended crosswise on the opposite sides with respect to each center conductor and these ends are closely opposing to each other to increase the degree of coupling.

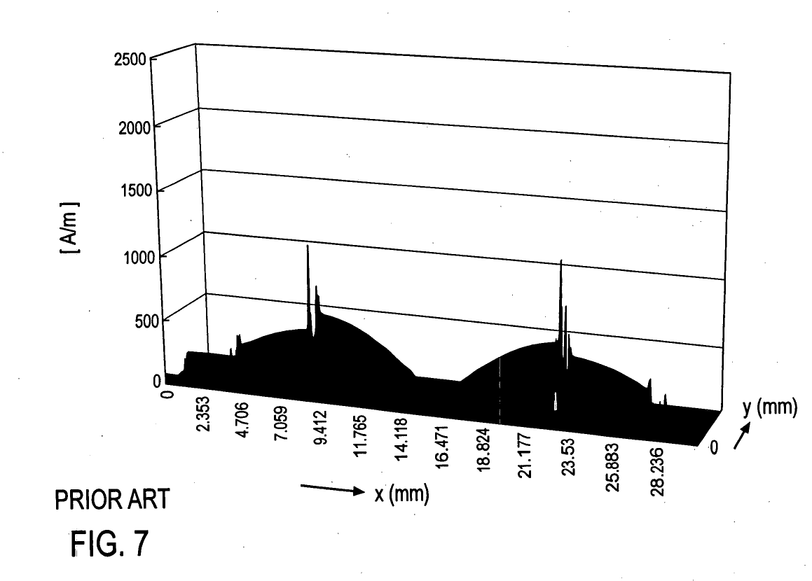

In the filter shown in FIG. 6, the first input/output terminal section 4a has a characteristic impedance of 50Ω and the resonator has a characteristic impedance of 100Ω. Assuming that the first input/output terminal section 4a has a ground conductor spacing dᵢₒ of 0.4 mm and a center conductor width wᵢₒ of 0.218 mm and the resonator has a ground conductor spacing d₁ of 1.780 mm and a center conductor width w₁ of 0.218 mm, a simulation for the current density distribution in the one-quarter wavelength four stage coplanar waveguide filter of this numerical example has been made and its result is shown in FIG. 7.

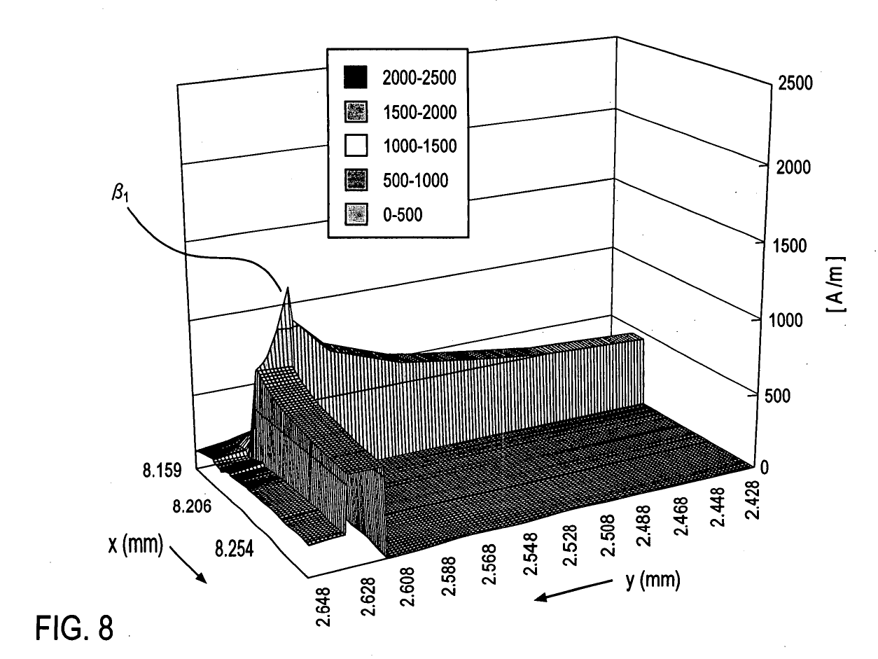

X-axis represents a position in a direction along the length of the coplanar waveguide filter, y-axis represents a crosswise position, and the ordinate represents a current density. The current density distribution has nodes at the capacitive couplers 6a to 6c and anti-nodes at the inductive couplers 8a and 8b, thus assuming a substantially lunate waveform. A current density distribution on a line VIII-VIII indicated on the shorting line conductors 7a1 and 7a2 in FIG. 6 is shown to an enlarged scale in FIG. 8. The current density is at its maximum at the first inductive coupler 8a which is located at a distance of about 8.0 mm from the input end of the coplanar line and also at the second inductive coupler 8b which is located at a distance of about 22 mm from the input end. The peak of the current density is about 1200A/m. FIG. 8 graphically shows a current density distribution of the first inductive coupler 8a to an enlarged scale. A position located at a distance of 8.159 mm from the signal input end of the first input/output terminal section 4a lies on the shorting line conductor 7a1 and corresponds to a portion indicated by the line VIII-VIII shown in FIG. 6. Thus, an X-axis position which is stepped back by about 0.02 mm toward the input from the lateral edge of the shorting line conductor 7a1 which is disposed toward the resonator 5b represents the 8.159 mm position shown in FIG. 8. FIG. 8 shows a current density distribution in a range extending about 0.1 mm toward the output from this position. A current concentration occurs at a corner β where the shorting line conductor 7a1 contacts the center conductor 2_{R2}, but there is no current concentration at any other corner.

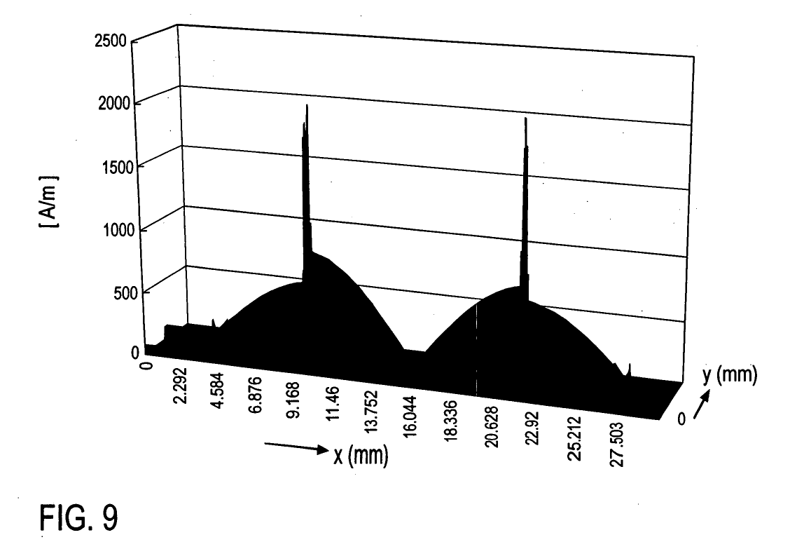

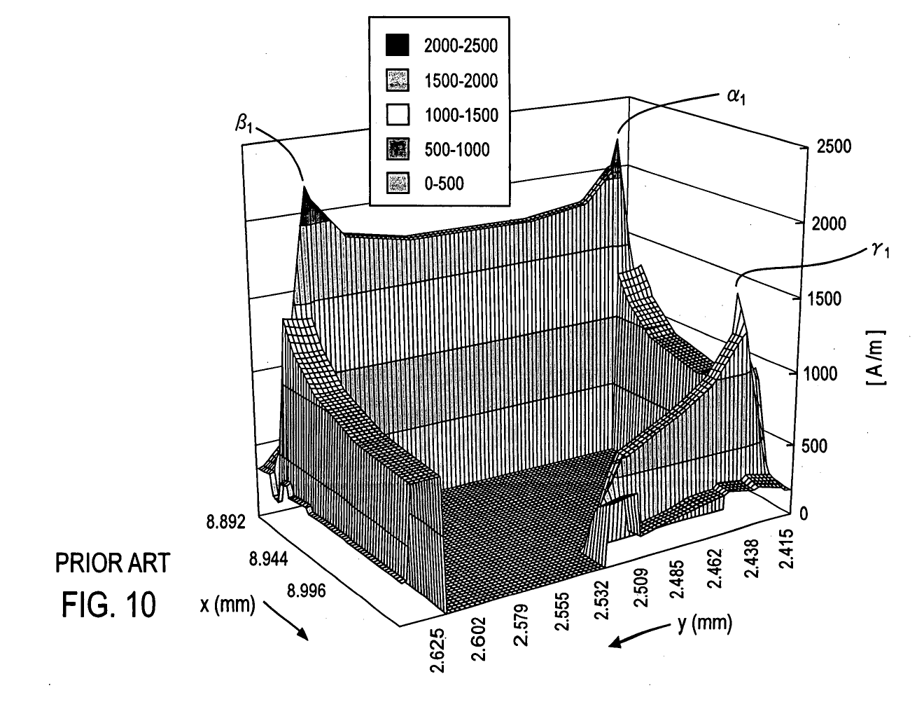

For the sake of reference, a result of simulation for the current density distribution performed on the coplanar waveguide filter shown in FIG. 2 when the first and the second input/output terminal section 4a and 4b each have a width wᵢₒ of 0.218 mm for the center conductors 2₄ₐ and 2_{4b} and a ground conductor spacing d₁ of 0.4 mm and the resonators 5a to 5d each have a width w₁ of 0.218 mm for the respective center conductor 2_{R1} to 2_{R4} and a ground conductor spacing d₁ of 0.4 mm, and thus have the same values as the input/output terminal sections 4a and 4b is shown in FIGS. 9 and 10, which correspond to FIGS. 7 and 8, respectively. In the similar manner as in FIG. 7, the current density is at its maximum at the edge line 9 (shown in thick line in FIG. 2) of the first and the second inductive coupler 8a and 8b, and exhibits a maximum value of about 2200 A/m at the first inductive coupler 8a which is located at a distance of about 8.5 mm from the input end of the coplanar waveguide filter and also at the second inductive coupler 8b which is located at a distance of about 20 mm from the input. A position shown at 8.892 mm on the X-axis in FIG. 10 corresponds to a portion indicated by the line X-X in FIG. 2. Specifically, an X-axis position which is stepped back by 0.014 mm toward the input from the lateral edge of the shorting line conductor 7a1 which is disposed toward the second resonator 5b represents a position of 8.8917 mm in FIG. 10. FIG. 10 shows a current density distribution in a range of 0.1 mm extending from this position toward the output. It will be seen that the current density is particularly high at two locations including the corner α where the shorting line conductor 7a1 contacts the first ground conductor 3a and the corner β where the shorting line conductor 7a1 contacts the center conductor 2_{R2}, and that the current concentration occurs at the corner γ which is located opposite from the corner α of the rectangular cut 20 into the first ground conductor 3a which is provided for the purpose of increasing the degree of coupling of the inductive coupler 8. Such a current concentration has peaks also at corners which are disposed in line symmetry to the corners α, β and γ with respect to a centerline of the width of the shorting line conductor 7al. In this manner, a particularly high current concentration peak occurs at three locations including the corners α, β and γ. It is obvious that the same tendency prevails at corners which are formed between the shorting line conductor 7a2 and the center conductor 2_{R2} and the second ground conductor 3b.

It is seen from the above that the filter shown in FIG. 6 has a single peak of the current density with a peak value of about 1200 A/m which is reduced as compared with the filter shown in FIG. 2 and is suppressed to a magnitude of about 55% of the prior art. The current density in each of the resonators 5a to 5b is reduced, achieving a reduction in the maximum current density of about 45% which is converted into a power reduction of about 70%.

It should be noted that using the characteristic impedance of the resonator which is equal to 100Ω produces a mismatch of the characteristic impedance at the first and the second input/output terminal section 4a and 4b. In this respect, for the first input/output terminal section 4a, the first capacitive coupler 6a which is connected between the first input/output terminal section 4a and the first resonator 5a acts as an impedance converter, preventing a reflection loss from occurring. Similarly, for the second input/output terminal section 4b, the third capacitive coupler 6c acts as an impedance converter.

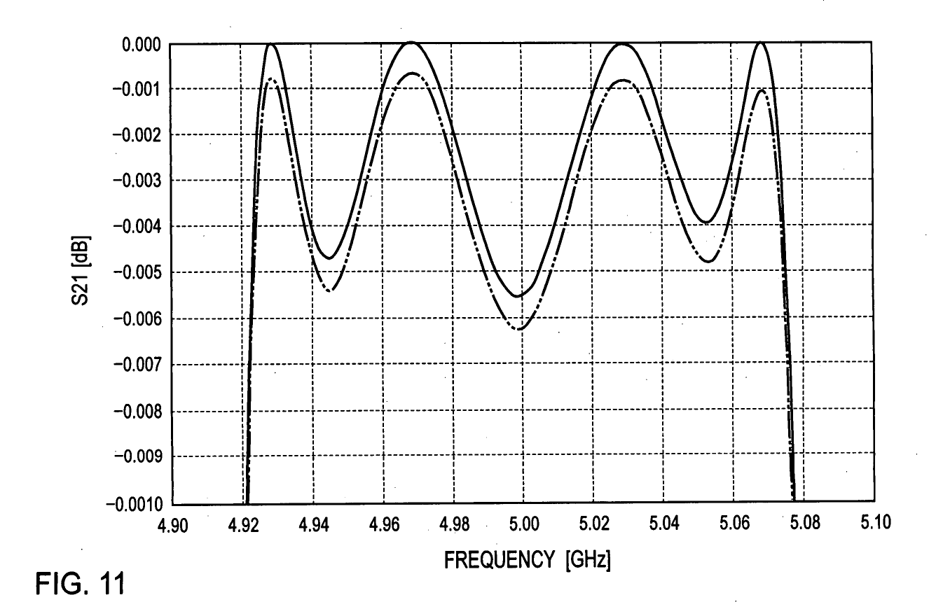

FIG. 11 graphically shows a result of a simulation performed for an in-band insertion loss of the coplanar waveguide filter shown in FIG. 6 when it is contained within the metal casing 10 shown in FIG. 3 and when it is contained within the casing 21 of the embodiment shown in FIG. 4. The filter which is contained in the casing has sizes mentioned previously, the dielectric substrate 1 has a thickness D_{F} of 0.5 mm, the casings 10 and 21 have an equal size having numerical figures mentioned previously, and spacing S_{c} between the surface of the dielectric substrate 1 on which the center conductor and the ground conductors are formed and the casing 10 or 21 as the filter is contained within the casing is equal to 4.5 mm. The metal casing 10 comprises a casing formed by copper plates evaporated with gold thereon, and the superconductor layer 23 of the casing 21 assumes a superconducting state and thus is assumed to present a resistance of 0 for purpose of simulation.

In FIG. 11, the abscissa represents the frequency, and the ordinate the transmittance S21, and chain lines indicated the transmittance when contained within the metal case 10 while the solid line indicates the transmittance when contained within the casing 21. It will be noted from FIG. 11 that the in-band insertion loss is about 0.00063 dB when the metal casing 10 is used and is equal to about 0.00055 dB when the casing 21 having the superconductor layer 23 formed on the internal surface thereof is used, thus allowing a reduction over the former of about 0.001 dB.

While the filter insertion loss can be reduced by forming the center conductor and the ground conductors of the coplanar waveguide filter with a superconductor or a high temperature superconductor, it will be noted that when the arrangement of the coplanar waveguide filter shown in FIG. 6 is used, a current flow through the filter is reduced due to an increased characteristic impedance and the number of locations where peaks occur in the current density distribution is reduced with a reduced peak value, thus allowing a filter insertion loss to be substantially reduced.

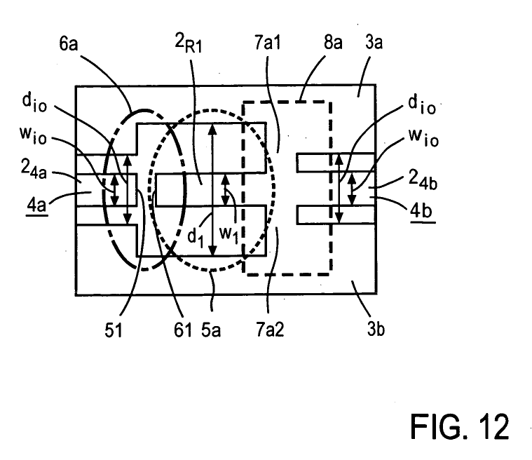

In the foregoing, an example in which the four resonators 5a to 5b have been connected in series has been described, but it should be understood that the number of resonators are not limited to four. Even a single stage of resonator can function as a filter. An example of a filter which is formed by a single stage resonator is shown in FIG. 12. One end of a center conductor 2_{R1} of a first resonator 5a is coupled to a first input/output terminal section 4a by a first capacitive coupler 6a, and the other end of the center conductor 2_{R1} is coupled to a second input/output terminal section 4b through a first inductive coupler 8a. The center conductor width wᵢₒ of the first and the second input/output terminal section 4a and 4b is chosen to be equal to the center conductor line width w₁ of the resonator while the ground conductor spacing d₁ of the resonator 5a is chosen to be greater than the ground conductor spacing dᵢₒ of the first and the second input/output terminal section 4a and 4b. A capacitive coupling end 51 of the first capacitive coupler 6a which is disposed toward the input/output terminal section 4a represents a simple extension of the center conductor 2₄ₐ, and a capacitive coupling end 61 disposed toward the center conductor 2_{R1} and which opposes the coupling end 51 is directly defined by the center conductor 2_{R1} itself. Accordingly, the first capacitive coupler 6a has a strength of coupling which is less than that of the first capacitive coupler 6a shown in FIG. 6.

The center conductor 2_{4b} of the second input/output terminal section 4b is directly connected with shorting line conductors 7a1 and 7a2, thus coupling the resonator 5a and the second input/output terminal section 4b through an inductive coupler 8a. The coupling between the resonator and the input/output terminal section is set up in accordance with a balance of a design for the strength of coupling, and may comprise either a capacitive or an inductive coupling.

In order to allow different characteristic impedances to be used for an input/output terminal section and a resonator in a coplanar waveguide filter, the center conductor width w₁, of the resonator may be chosen to be greater than the center conductor width wᵢₒ of the input/output terminal section while the ground conductor spacing dᵢₒ of the input/output terminal section and the ground conductor spacing d₁ of the resonator are chosen to be equal to each other, thereby providing a reduced characteristic impedance for the resonator than for the input/output terminal section.

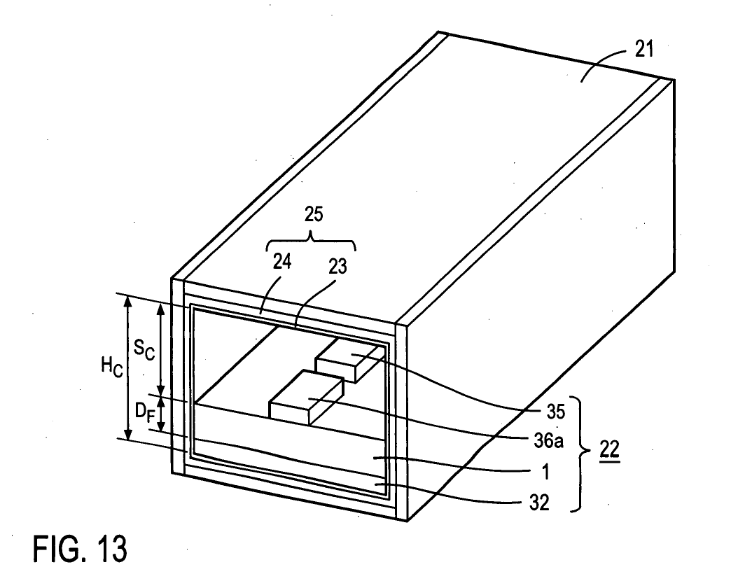

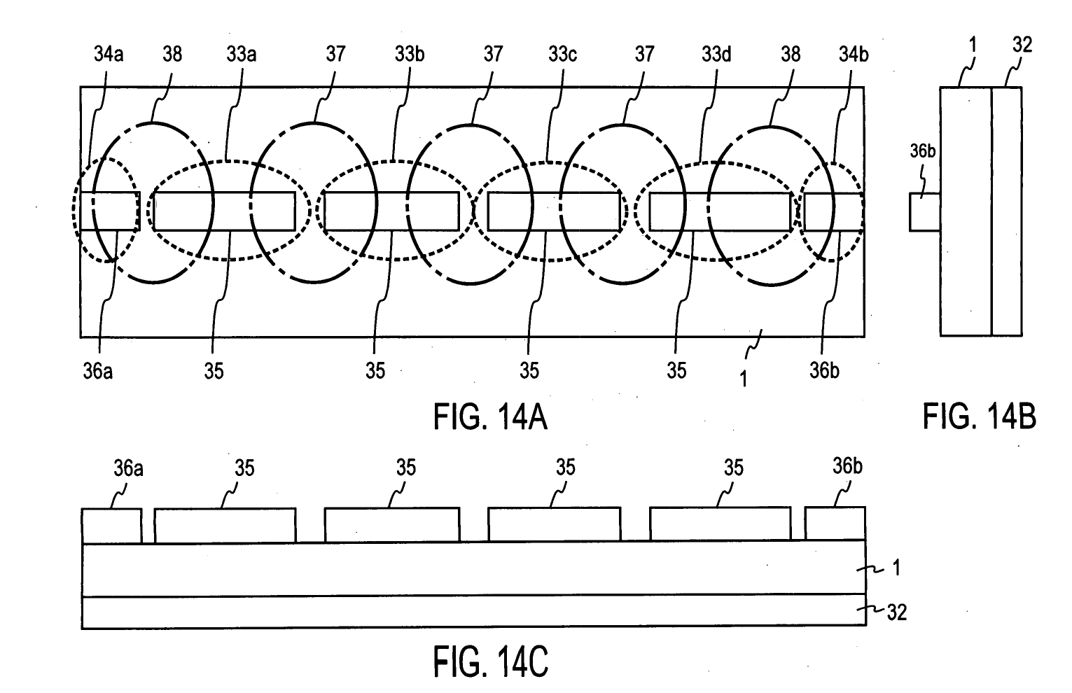

It should be understood that the resonator used in accordance with the invention is not limited to a coplanar resonator, but may comprise a microstrip line resonator, for example. FIG. 13 shows an embodiment therefor. A square tubular casing 21 has a superconductor layer 23 formed on its internal surface in the similar manner as shown in FIG. 4. A microstrip line filter 31 is contained within the casing 21. An example of the microstrip line filter 31 is shown in FIGS. 14A to 14C. A ground conductor 32 is formed on one surface of a dielectric substrate 1, which is the entire bottom surface thereof in the example shown. A plurality of microstrip line resonators 33a to 33d which cooperate with the ground conductor 32 are formed on the other surface, which is the top surface, of the dielectric substrate 1 on a line and are sequentially coupled together electromagnetically as an array. Line input/output terminal sections 34a and 34b which functions as microstip lines together with the ground conductor 32 are formed at the opposite ends of the array of the resonators 33a to 33d.

In this example, each of the resonators 33a to 33d comprises a filter signal line 35 having an electrical length equal to one-half wavelength which is formed on the dielectric substrate 1, and the signal lines 35 of the respective resonators 33a to 33d are disposed in a linear array in the direction of the array of the resonators. Input/output signal lines 36a and 36b which functions as microstrip lines by cooperation with the ground conductor 32 are formed on the dielectric substrate 1 in alignment with the array of the signal lines 35 at the opposite ends thereof. Opposing edges of filter signal lines 35 of adjacent resonators are disposed in opposing relationship with each other with a spacing which assures a required degree of coupling, thus forming a capacitive coupler 37. Finally, the filter signal lines 35 of the resonators 33a and 33d and the input/output signal lines 36a and 36b of the input/output terminal sections 34a and 34b have their opposing edges disposed closely spaced from each other, thus forming capacitive couplers 38.

In this microstrip line filter 31, there is no irradiation of electromagnetic power from the ground conductor 32, and accordingly, the ground conductor 32 is contained within the casing 21 while it is in contact with one sidewall thereof. As a consequence, the height H_{c} of the casing 21 can be reduced. In addition, the internal wall surface of the casing 21 which is in contact with the ground conductor 32 may be left without a superconductor layer 23, and the ground conductor 32 may be directly applied to the internal surface of the casing 21 itself.

While a filter which is contained within the casing 21 has been principally described in terms of a coplanar waveguide, a cavity resonator type structure, a microstrip line structure, a coplanar line structure of flat circuit type using slotline or coplanar strips as well as a variety of many other structures may be adopted according to the present invention. In the described embodiments, a center conductor of the coplanar waveguide filter and a signal line of a microstrip line are collectively referred to as a signal conductor. A coplanar waveguide filter with a ground conductor may be contained within the casing 21. In this instance, the ground conductor may be brought into contact with the internal wall surface of the casing 21 when it is contained therein.

1. A casing contained filter comprising a filter formed on a dielectric substrate and a casing in which the filter is contained;
the filter comprising at least one resonator formed on the dielectric substrate and a first and a second input/output terminal section formed on the dielectric substrate and coupled with the resonator;
the resonator comprising a signal conductor formed on one surface of the dielectric substrate and a ground conductor formed on at least one of said one surface and the opposite surface of the dielectric substrate;
the casing having a superconductor layer formed on the internal wall thereof.

2. A casing contained filter according to claim 1 in which the first and the second input/output terminal section have a characteristic impedance which is different from the characteristic impedance of the resonator.

3. A casing contained filter according to claim 1 in which the filter comprises a coplanar waveguide filter and the resonator comprises the signal conductor, and a first and a second ground conductor formed on the same surface of the dielectric substrate and on the opposite sides of and in parallel relationship with the signal conductor, the opposite surfaces of the dielectric substrate being spaced from opposing internal surfaces of the casing.

4. A casing contained filter according to claim 1 in which the filter comprises a microstrip line filter and the resonator comprises a signal conductor formed on one surface of the dielectric substrate and a ground conductor formed on the other surface of the dielectric surface over the entire area, the surface of the dielectric substrate on which at least the signal conductor is formed being spaced from the opposing internal surface of the casing.

5. A casing contained filter according to claim 4 in which the surface of the casing which opposes the ground conductor is not formed with the superconductor layer.

6. A casing contained filter according to claim 1 in which the casing comprises a square tubular body of copper plate which is plated with gold, and a high temperature superconductor such as lanthanum-, yttrium-, bisuth- or thallium- superconductor is deposited as a film on a substrate of a metal oxide material such as MgO, SrTiO₃, LaGaO₃, LaAlO₃ to provide a superconductor filmed substrate which is applied to the internal wall of the square tubular body.
